(19) United States
(12) Patent Application Publication
(10) Pub. No.: US 2025/0205637 A1
(43) Pub. Date: Jun. 26, 2025

(54) GAS SEPARATION MEMBRANE

(71) Applicant: IDEMITSU KOSAN CO., LTD., Tokyo (JP)

(72) Inventors: Satoshi MIYANE, Chiyoda-ku, Tokyo (JP); Hirotoshi ISHII, Chiyoda-ku, Tokyo (JP); Kazushige IDETA, Chiyoda-ku, Tokyo (JP); Yasuhiro ISHIKAWA, Chiyoda-ku, Tokyo (JP)

(73) Assignee: IDEMITSU KOSAN CO., LTD., Tokyo (JP)

(21) Appl. No.: 18/847,487

(22) PCT Filed: Mar. 17, 2023
(86) PCT No.: PCT/JP2023/010723

§ 371 Date: Sep. 16, 2024

(30) Foreign Application Priority Data
Mar. 18, 2022 (JP) 2022-044173

(51) Int. Cl. B01D 53/22; B01D 67/00; B01D 69/02; B01D 71/70; B01D 71/80

(52) U.S. Cl. CPC B01D 53/228; B01D 67/002; B01D 69/02; B01D 71/701; B01D 71/80; B01D 2257/504; B01D 2325/04; B01D 2325/24; B01D 2325/34

(57) ABSTRACT

The present invention relates to a gas separation membrane for separating carbon dioxide from a mixed gas containing the carbon dioxide, the gas separation membrane including a polycarbonate-polyorganosiloxane copolymer (A), wherein the polycarbonate-polyorganosiloxane copolymer (A) contains a polycarbonate block (A-1) consisting of repetition of a structural unit represented by the following general formula (I) and a polyorganosiloxane block (A-2) including repetition of a structural unit represented by the following general formula (II), and wherein a content of the polyorganosiloxane block (A-2) in the polycarbonate-polyorganosiloxane copolymer (A) is from 20 mass % or more to 70 mass % or less:

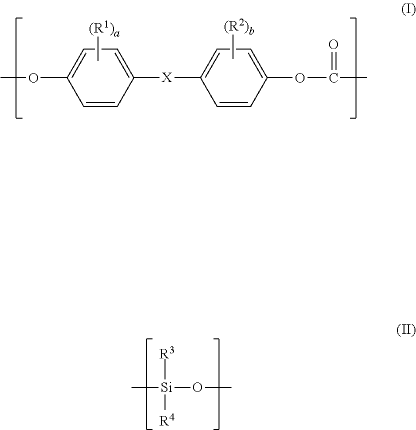

wherein R¹, R², R³, R⁴, X, “a”, and “b” are as defined in Description.

### TECHNICAL FIELD

The present invention relates to a gas separation membrane, a use of a polymer membrane, and a method of separating carbon dioxide from a mixed gas containing the carbon dioxide.

### BACKGROUND ART

Carbon dioxide in an exhaust gas from a power plant, a factory, or the like has been considered to be a cause for global warming. Accordingly, various methods of separating and recovering the carbon dioxide from the exhaust gas have been investigated.

In Patent Literature 1, as a polymer membrane having high gas transmittance, there is a disclosure of a gas transmission membrane that is a polymer having a specific structure using a siloxane bond (—Si—O—Si—) as a main chain.

In addition, a polycarbonate-polyorganosiloxane copolymer (hereinafter sometimes abbreviated as “PC-POS copolymer”) has been attracting attention because of its excellent properties, such as high impact resistance, chemical resistance, and flame retardancy. Accordingly, the polycarbonate-polyorganosiloxane copolymer has been expected to be widely utilized in various fields, such as the field of electrical and electronic equipment and the field of automobiles. In particular, the utilization of the polycarbonate-polyorganosiloxane copolymer in casings for a cellular phone, a mobile personal computer, a digital camera, a video camera, an electric tool, and the like, and in other commodities has been expanding.

However, no investigation has been made on the application of the polycarbonate-polyorganosiloxane copolymer as a gas separation membrane for separating carbon dioxide.

### CITATION LIST

### Patent Literature

PTL 1: JP 2018-15678 A

### SUMMARY OF INVENTION

### Technical Problem

In the technology disclosed in Patent Literature 1, the selectivity and transmission amount of a carbon dioxide gas have been insufficient. In addition, the mechanical strength of the gas transmission membrane has been insufficient.

The present invention relates to a gas separation membrane for separating carbon dioxide from a mixed gas containing the carbon dioxide, the membrane being excellent in selectivity and transmission amount of the carbon dioxide, and being also excellent in mechanical strength.

### Solution to Problem

The inventors of the present invention have found that the above-mentioned problem can be solved by a gas separation membrane including a specific polycarbonate-polyorganosiloxane copolymer.

That is, the present invention relates to the following items [1] to [8].

[1] A gas separation membrane for separating carbon dioxide from a mixed gas containing the carbon dioxide, the gas separation membrane including a polycarbonate-polyorganosiloxane copolymer (A),
wherein the polycarbonate-polyorganosiloxane copolymer (A) contains a polycarbonate block (A-1) consisting of repetition of a structural unit represented by the following general formula (I) and a polyorganosiloxane block (A-2) including repetition of a structural unit represented by the following general formula (II), and
wherein a content of the polyorganosiloxane block (A-2) in the polycarbonate-polyorganosiloxane copolymer (A) is from 20 mass % or more to 70 mass % or less:

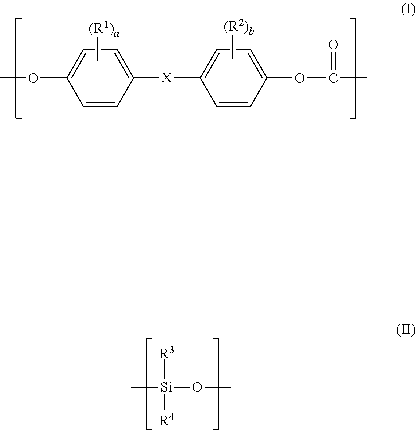

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.
   [2] The gas separation membrane according to the above-mentioned item [1], wherein the polyorganosiloxane block (A-2) has an average chain length “n” of from 20 to 150.
   [3] The gas separation membrane according to the above-mentioned item [1] or [2], wherein in the general formula (I), “a” and “b” each represent 0, and X represents an isopropylidene group.
   [4] The gas separation membrane according to any one of the above-mentioned items [1] to [3], wherein in the general formula (II), R³ and R⁴ each represent a methyl group.
   [5] The gas separation membrane according to any one of the above-mentioned items [1] to [4], wherein a product of a carbon dioxide transmission coefficient [unit: Barrer] of the gas separation membrane and a thickness [unit: μm] thereof is 5.0×10³ or more.
   [6] The gas separation membrane according to any one of the above-mentioned items [1] to [5], wherein the mixed gas containing the carbon dioxide is an exhaust gas.
   [7] A use of a polymer membrane including a polycarbonate-polyorganosiloxane copolymer (A) for separation of carbon dioxide from a mixed gas containing the carbon dioxide,
wherein the polycarbonate-polyorganosiloxane copolymer (A) contains a polycarbonate block (A-1) consisting of repetition of a structural unit represented by the following general formula (I) and a polyorganosiloxane block (A-2) including repetition of a structural unit represented by the following general formula (II), and
wherein a content of the polyorganosiloxane block (A-2) in the polycarbonate-polyorganosiloxane copolymer (A) is from 20 mass % or more to 70 mass % or less:

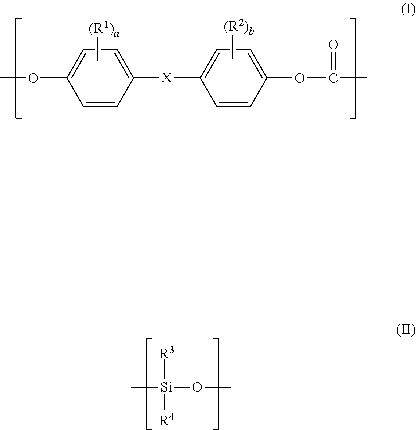

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.
   [8] A method of separating carbon dioxide from a mixed gas containing the carbon dioxide, including a step of bringing the mixed gas containing the carbon dioxide into contact with a gas separation membrane,
wherein the gas separation membrane includes a polycarbonate-polyorganosiloxane copolymer (A),
wherein the polycarbonate-polyorganosiloxane copolymer (A) contains a polycarbonate block (A-1) consisting of repetition of a structural unit represented by the following general formula (I) and a polyorganosiloxane block (A-2) including repetition of a structural unit represented by the following general formula (II), and
wherein a content of the polyorganosiloxane block (A-2) in the polycarbonate-polyorganosiloxane copolymer (A) is from 20 mass % or more to 70 mass % or less:

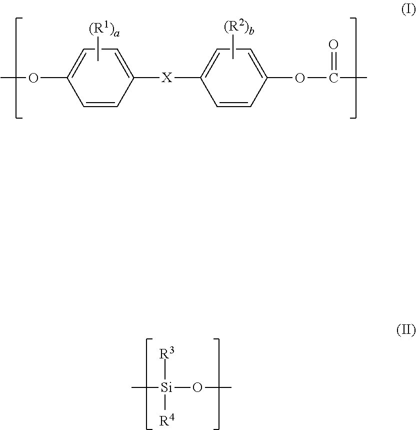

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

### Advantageous Effects of Invention

According to the present invention, the gas separation membrane for separating carbon dioxide from a mixed gas containing the carbon dioxide, the membrane being excellent in selectivity and transmission amount of the carbon dioxide, and being also excellent in mechanical strength, can be provided. Further, the use of a polymer membrane and the method of separating carbon dioxide from a mixed gas containing the carbon dioxide can be provided by applying this technology.

### DESCRIPTION OF EMBODIMENTS

A gas separation membrane of the present invention is a gas separation membrane for separating carbon dioxide from a mixed gas containing the carbon dioxide, the gas separation membrane including a polycarbonate-polyorganosiloxane copolymer (A),
wherein the polycarbonate-polyorganosiloxane copolymer (A) contains a polycarbonate block (A-1) consisting of repetition of a structural unit represented by the following general formula (I) and a polyorganosiloxane block (A-2) including repetition of a structural unit represented by the following general formula (II), and
wherein the content of the polyorganosiloxane block (A-2) in the polycarbonate-polyorganosiloxane copolymer (A) is from 20 mass % or more to 70 mass % or less:

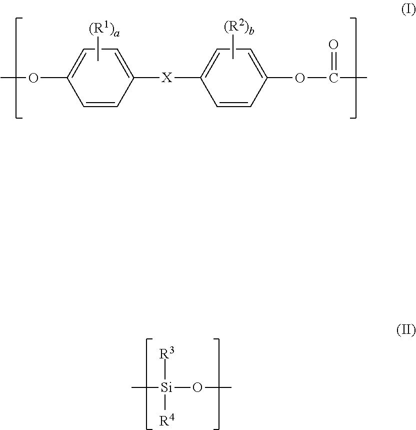

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

The gas separation membrane of the present invention is described in detail below. Herein, a specification considered to be preferred may be arbitrarily adopted, and a combination of preferred specifications can be said to be more preferred. The term “from XX to YY” as used herein means “from XX or more to YY or less.”

### [Gas Separation Membrane]

The gas separation membrane of the present invention is a gas separation membrane for separating carbon dioxide from a mixed gas containing the carbon dioxide, the gas separation membrane including the specific polycarbonate-polyorganosiloxane copolymer (A).

### <Polycarbonate-Polyorganosiloxane Copolymer (A)>

The gas separation membrane of the present invention includes the polycarbonate-polyorganosiloxane copolymer (A) containing the polycarbonate block (A-1) consisting of repetition of a structural unit represented by the following general formula (I) and the polyorganosiloxane block (A-2) including repetition of a structural unit represented by the following general formula (II), and having a content of the polyorganosiloxane block (A-2) in the polycarbonate-polyorganosiloxane copolymer (A) of from 20 mass % or more to 70 mass % or less:

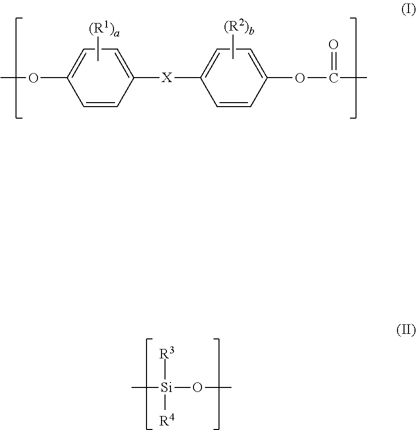

wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

### (Polycarbonate Block (A-1))

The polycarbonate block (A-1) is consisting of the repetition of the structural unit represented by the general formula (I).

In the general formula (I), examples of the halogen atom that R¹ and R² each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (the term “various” means that a linear group and all kinds of branched groups are included, and in this description, the same holds true for the following), various pentyl groups, and various hexyl groups. Examples of the alkoxy group that R¹ and R² each independently represent include alkoxy groups having the above-mentioned alkyl groups as alkyl group moieties.

Examples of the alkylene group represented by X include a methylene group, an ethylene group, a trimethylene group, a tetramethylene group, and a hexamethylene group. Among them, an alkylene group having 1 to 5 carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 to 10 carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred. Examples of the aryl moiety of the arylalkylene group represented by X include aryl groups each having 6 to 14 ring-forming carbon atoms, such as a phenyl group, a naphthyl group, a biphenyl group, and an anthryl group, and examples of the alkylene group include the above-mentioned alkylene groups. Examples of the aryl moiety of the arylalkylidene group represented by X include aryl groups each having 6 to 14 ring-forming carbon atoms, such as a phenyl group, a naphthyl group, a biphenyl group, and an anthryl group, and examples of the alkylidene group may include the above-mentioned alkylidene groups.

Symbols “a” and “b” each independently represent an integer of from 0 to 4, preferably from 0 to 2, more preferably 0 or 1.

Among them, it is preferred that “a” and “b” each represent 0, and X represent a single bond, an alkylene group having 1 to 8 carbon atoms, or an alkylidene group having 2 to 8 carbon atoms, it is more preferred that “a” and “b” each represent 0, and X represent an alkylidene group having 3 carbon atoms, and it is still more preferred that “a” and “b” each represent 0, and X represent an isopropylidene group.

It is preferred that the polycarbonate-polyorganosiloxane copolymer (A) be substantially free of a polycarbonate block except the polycarbonate block (A-1).

The term “polycarbonate block” refers to a block structure mainly including the repetition of a structural unit represented by the following general formula (V):

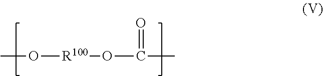

wherein R¹⁰⁰ represents an organic group, and R¹⁰⁰ preferably represents a divalent aliphatic hydrocarbon group having 2 to 40 carbon atoms, a divalent alicyclic hydrocarbon group having 3 to 40 carbon atoms, or a divalent aromatic hydrocarbon group having 6 to 20 carbon atoms, and these groups may each be substituted with a substituent, and may each contain at least one atom selected from the group consisting of: an oxygen atom; a nitrogen atom; a sulfur atom; and a halogen atom.

Examples of the polycarbonate block that does not form the polycarbonate block (A-1) include polycarbonate blocks each obtained by using a dihydroxydiarylfluorene, such as 9,9-bis(4-hydroxyphenyl) fluorene (also referred to as “BFL”) or 9,9-bis(4-hydroxy-3-methylphenyl) fluorene (also referred to as “BCFL”), as a dihydric phenol-based compound.

The phrase “substantially free” means that the content of the polycarbonate block except the polycarbonate block (A-1) in the polycarbonate-polyorganosiloxane copolymer (A) is preferably 5 mass % or less, more preferably 1 mass % or less, still more preferably 0.5 mass % or less, still further more preferably 0 mass % in all polycarbonate blocks.

In other words, the content of the polycarbonate block (A-1) in all the polycarbonate blocks is preferably 95 mass % or more, more preferably 99 mass % or more, still more preferably 99.5 mass % or more, still further more preferably 100 mass %.

### (Polyorganosiloxane Block (A-2))

The polyorganosiloxane block (A-2) is a block structure present between two polycarbonate bonds most adjacent to each other on the main chain of the polycarbonate-polyorganosiloxane copolymer (A), and contains at least one repetition of the structural unit represented by the general formula (II).

In the general formula (II), examples of the halogen atom that R³ and R⁴ each independently represent include a fluorine atom, a chlorine atom, a bromine atom, and an iodine atom. Examples of the alkyl group that R³ and R⁴ each independently represent include a methyl group, an ethyl group, a n-propyl group, an isopropyl group, various butyl groups, various pentyl groups, and various hexyl groups. Examples of the alkoxy group that R³ and R⁴ each independently represent include alkoxy groups having the above-mentioned alkyl groups as alkyl group moieties. Examples of the aryl group that R³ and R⁴ each independently represent include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

### Average Chain Length of Polyorganosiloxane Block (A-2)

The average chain length “n” of the polyorganosiloxane block (A-2) in the polycarbonate-polyorganosiloxane copolymer (A) is preferably from 20 to 150, more preferably from 25 to 90, still more preferably from 30 to 50, still further more preferably from 35 to 45. When the average chain length falls within the above-mentioned ranges, there can be obtained a gas separation membrane having more excellent selectivity, and a more excellent transmission amount, of carbon dioxide, and more excellent mechanical strength.

The average chain length of the polyorganosiloxane block (A-2) is the average number of —SiR³R⁴-groups in the polyorganosiloxane block (A-2) present between two polycarbonate bonds most adjacent to each other on the main chain of the polycarbonate-polyorganosiloxane copolymer (A). In addition, the average number of repetitions of the repeating unit represented by the general formula (II) in the polyorganosiloxane block (A-2) is n−1.

The average chain length “n” of the polyorganosiloxane block (A-2) in the polycarbonate-polyorganosiloxane copolymer (A) is calculated by nuclear magnetic resonance (NMR) measurement.

### Content of Polyorganosiloxane Block (A-2)

The content of the polyorganosiloxane block (A-2) (also referred to as “polyorganosiloxane amount”) in the polycarbonate-polyorganosiloxane copolymer (A) is from 20 mass % or more to 70 mass % or less. When the polyorganosiloxane amount in the polycarbonate-polyorganosiloxane copolymer (A) falls within the above-mentioned range, there can be obtained a gas separation membrane having excellent selectivity, and an excellent transmission amount, of carbon dioxide, and excellent mechanical strength.

In one preferred aspect of the present invention, the content of the polyorganosiloxane block (A-2) in the polycarbonate-polyorganosiloxane copolymer (A) is preferably from 30 mass % or more to 70 mass % or less, more preferably from 35 mass % or more to 65 mass % or less, still more preferably from 40 mass % or more to 60 mass % or less. When the polyorganosiloxane amount in the polycarbonate-polyorganosiloxane copolymer (A) falls within the above-mentioned ranges, there can be obtained a gas separation membrane having excellent selectivity, and an excellent transmission amount, of carbon dioxide, and excellent mechanical strength.

In another preferred aspect of the present invention, the content of the polyorganosiloxane block (A-2) in the polycarbonate-polyorganosiloxane copolymer (A) is preferably from 20 mass % or more to 60 mass % or less, more preferably from 20 mass % or more to 50 mass % or less, still more preferably from 20 mass % or more to 30 mass % or less. When the polyorganosiloxane amount in the polycarbonate-polyorganosiloxane copolymer (A) falls within the above-mentioned ranges, there can be obtained a gas separation membrane having more excellent selectivity, and a more excellent transmission amount, of carbon dioxide, and more excellent mechanical strength.

The term “content of the polyorganosiloxane block (A-2) in the polycarbonate-polyorganosiloxane copolymer (A)” as used herein refers to the mass percentage of the general formula (II) with respect to the total mass of the polycarbonate block (A-1), the general formula (II), and as required, a terminal structure derived from a terminal stopper to be described later in the polycarbonate-polyorganosiloxane copolymer (A). The content of the polyorganosiloxane block (A-2) in the polycarbonate-polyorganosiloxane copolymer (A) is calculated by nuclear magnetic resonance (NMR) measurement. Specifically, 1H-NMR measurement is performed, and the content is calculated from the integrated values of a peak derived from the formula (I), a peak derived from the formula (II), and a peak derived from a terminal group.

A preferred aspect of the polyorganosiloxane block (A-2) containing the repeating unit represented by the general formula (II) is a block unit represented by any one of the following general formulae (II-I) to (II-III):

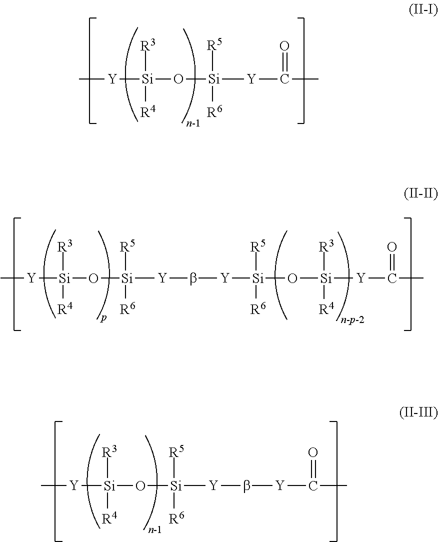

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s, R⁴s, R⁵s, or R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a halide of a dicarboxylic acid, “n” is as described above, and “p” represents an integer of from 1 or more to n−2 or less.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups, various pentyl groups, and various hexyl groups. Examples of the alkoxy group that R³ to R⁶ each independently represent include alkoxy groups having the above-mentioned alkyl groups as alkyl group moieties. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

R³ to R⁶ in the general formula (II-I), the general formula (II-II), and/or the general formula (II-III) each preferably represent a methyl group.

In —R⁷O—, —R⁷COO—, —R⁷NH—, —R⁷NR⁸—, —R⁷COO—R⁹—O—, or —R⁷O—R¹⁰—O— represented by Y, R⁷ is bonded to a Si atom. In —COO— represented by Y, a C atom is bonded to a Si atom.

The linear or branched alkylene group represented by R⁷ in —R⁷O—, —R⁷COO—, —R⁷NH—, —R⁷NR⁸—, —R⁷COO—R⁹—O—, or —R⁷O—R¹⁰—O— represented by Y is, for example, an alkylene group having 1 to 8 carbon atoms, preferably 1 to 5 carbon atoms. The cyclic alkylene group represented by R⁷ is, for example, a cycloalkylene group having 5 to 15 carbon atoms, preferably 5 to 10 carbon atoms.

The aryl-substituted alkylene group represented by R⁷ may have a substituent, such as an alkoxy group or an alkyl group, on its aromatic ring, and a specific structure thereof may be, for example, a structure represented by the following general formula (i) or (ii). Herein, when R⁷ represents the aryl-substituted alkylene group, the alkylene group is bonded to a Si atom. In the aryl-substituted alkylene group, in —R⁷O—, —R⁷COO—, —R⁷NH—, —R⁷NR⁸—, —R⁷COO—R⁹—O—, or —R⁷O—R¹⁰—O— represented by Y, the arylene group is bonded to an oxygen atom, a carbon atom, or a nitrogen atom adjacent to R⁷.

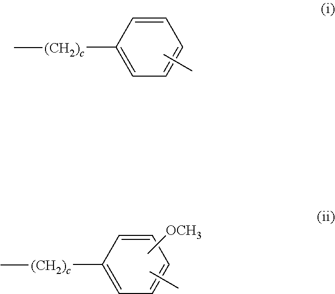

wherein “c” represents a positive integer and typically represents an integer of from 1 to 6.

The diarylene group represented by any one of R⁷, R⁹, and R¹⁰ refers to a group in which two arylene groups are linked to each other directly or through a divalent organic group, and is specifically a group having a structure represented by —Ar¹—W—Ar²—. Ar¹ and Ar² each represent an arylene group, and W represents a single bond or a divalent organic group. The divalent organic group represented by W is, for example, an isopropylidene group, a methylene group, a dimethylene group, or a trimethylene group.

Examples of the arylene group represented by any one of R⁷, Ar¹, and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched group having 1 to 8, preferably 1 to 5 carbon atoms. The alkenyl group represented by R⁸ is, for example, a linear or branched group having 2 to 8, preferably 2 to 5 carbon atoms. Examples of the aryl group represented by R⁸ include a phenyl group and a naphthyl group. Examples of the aralkyl group represented by R⁸ include a phenylmethyl group and a phenylethyl group.

The linear, branched, or cyclic alkylene group represented by R¹⁰ is the same as that represented by R⁷.

Y preferably represents —R⁷O— where R⁷ represents an aryl-substituted alkylene group. R⁷ more preferably represents a residue of, in particular, a phenol-based compound having an alkyl group among such groups, and still more preferably represents an organic residue derived from allylphenol or an organic residue derived from eugenol.

With regard to “p” in the formula (II-II), it is preferred that p=n−p−2.

β represents a divalent group derived from a diisocyanate compound, or a divalent group derived from a dicarboxylic acid or a halide of a dicarboxylic acid, and examples thereof include divalent groups represented by the following general formulae (iii) to (vii).

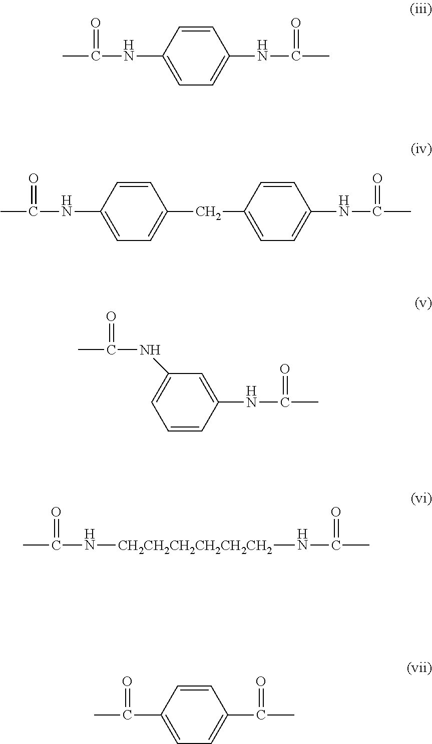

Examples of the block unit represented by the following general formula (II-I) include block units represented by the following general formulae (II-I-1) to (II-I-11):

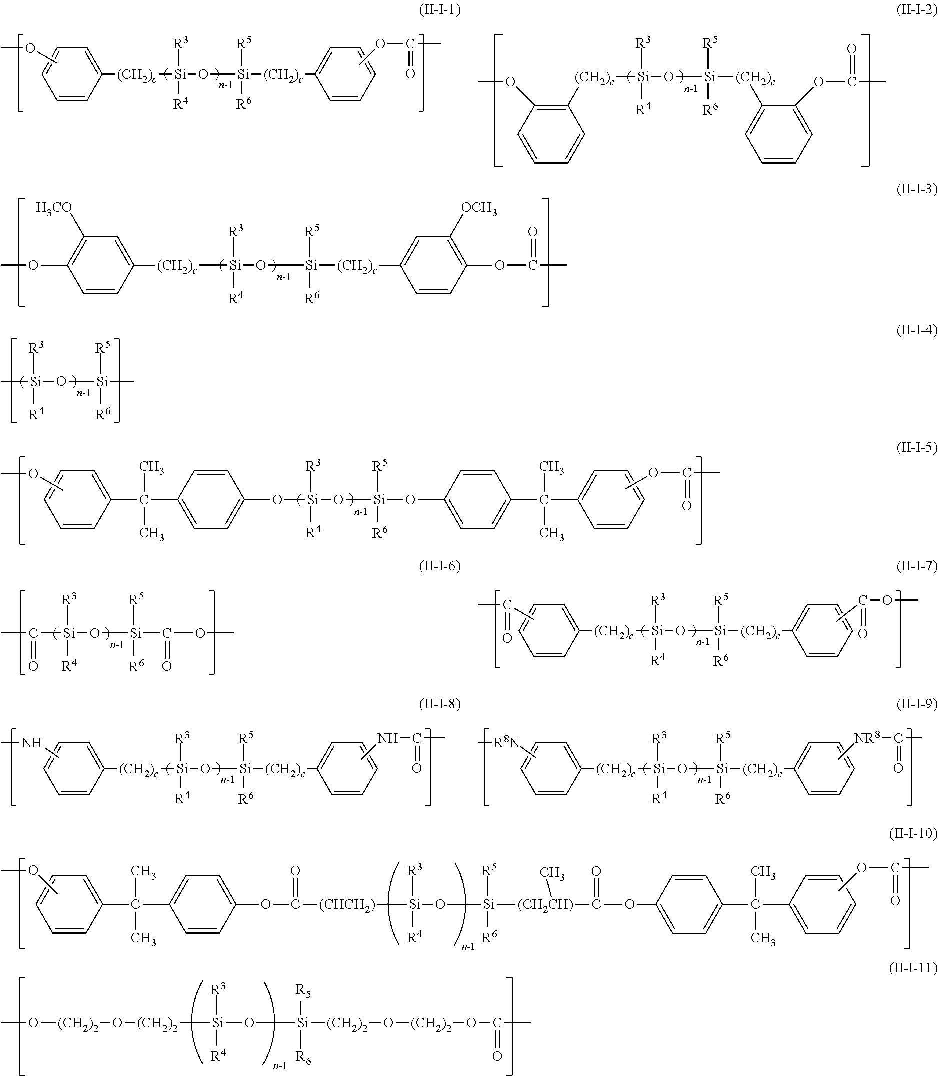

wherein in the general formulae (II-I-1) to (II-I-11), R³ to R⁶, n−1, and R⁸ are the same as those described above, and preferred examples thereof are also the same as those described above, and “c” represents a positive integer and typically represents an integer of from 1 to 6.

Among them, the block unit represented by the general formula (II-I-1) is preferred from the viewpoint of the ease with which a polyorganosiloxane is polymerized. In addition, the block unit represented by the general formula (II-I-2) or the block unit represented by the general formula (II-I-3) is preferred from the viewpoint of its ease of availability.

In addition, another preferred aspect of the polyorganosiloxane block (A-2) is, for example, a block unit represented by the following general formula (II-IV):

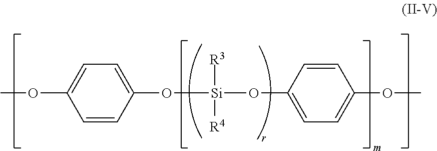

wherein R³ and R⁴ are the same as those described above, and r×m is equal to the “n”.

The average chain length of the polyorganosiloxane block represented by the general formula (II-IV) is (r×m), and the range of the (r×m) is the same as that of the “n”.

In addition, another preferred aspect of the polyorganosiloxane block (A-2) is, for example, a block unit represented by the following general formula (IV):

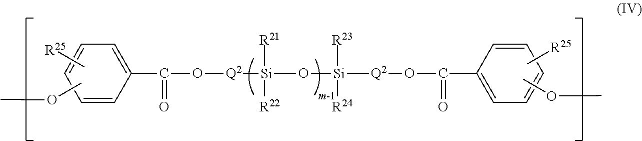

wherein R²¹ to R²⁴ each independently represent a hydrogen atom, a halogen atom, an alkyl group having 1 to 6 carbon atoms, an alkoxy group having 1 to 6 carbon atoms, or an aryl group having 6 to 12 carbon atoms, R²⁵ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length, and represents an integer of 10 or more.

Examples of the halogen atom that R²¹ to R²⁴ each independently represent include a fluorine atom, a chlorine atom, a bromine atom, and an iodine atom. Examples of the alkyl group that R²¹ to R²⁴ each independently represent include a methyl group, an ethyl group, a n-propyl group, an isopropyl group, various butyl groups, various pentyl groups, and various hexyl groups. Examples of the alkoxy group that R²¹ to R²⁴ each independently represent include alkoxy groups having the above-mentioned alkyl groups as alkyl group moieties. Examples of the aryl group that R²¹ to R²⁴ each independently represent include a phenyl group and a naphthyl group.

Examples of the alkyl group having 1 to 6 carbon atoms represented by R²⁵ include a methyl group, an ethyl group, a n-propyl group, an isopropyl group, various butyl groups, various pentyl groups, and various hexyl groups. Examples of the halogen atom represented by R²⁵ include a fluorine atom, a chlorine atom, a bromine atom, and an iodine atom. Examples of the alkoxy group having 1 to 6 carbon atoms represented by R²⁵ include alkoxy groups having the above-mentioned alkyl groups as alkyl group moieties. Examples of the aryl group having 6 to 14 carbon atoms represented by R²⁵ include a phenyl group, a toluyl group, a dimethylphenyl group, and a naphthyl group.

The divalent aliphatic group having 1 to 10 carbon atoms represented by Q² is preferably a linear or branched divalent saturated aliphatic group having 1 or more to 10 or less carbon atoms. The number of carbon atoms of the saturated aliphatic group is preferably from 1 or more to 8 or less, more preferably from 2 or more to 6 or less, still more preferably from 3 or more to 6 or less, still further more preferably from 4 or more to 6 or less.

“m” represents an average chain length, and represents an integer of 10 or more, preferably from 30 or more to 70 or less, more preferably from 30 or more to 60 or less, still more preferably from 30 or more to 50 or less, still further more preferably from 35 or more to 45 or less.

A specific mode of a repeating unit (A-3) may be, for example, a structure represented by the following formula (IV-I):

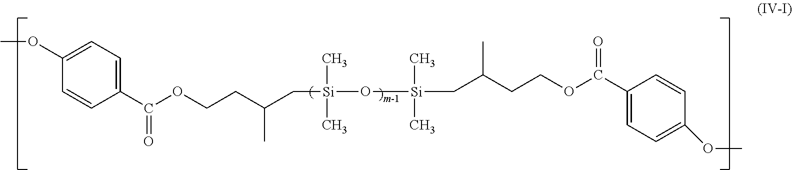

wherein “m” is as described above.

In a preferred aspect of the polycarbonate-polyorganosiloxane copolymer (A), the main chain of the polycarbonate-polyorganosiloxane copolymer (A) is consisting of the polycarbonate block (A-1), the polyorganosiloxane block (A-2), and as required, a terminal structure derived from a terminal stopper to be described later.

### (Physical Properties of Polycarbonate-Polyorganosiloxane Copolymer (A))

The viscosity-average molecular weight Mv of the polycarbonate-polyorganosiloxane copolymer (A) is preferably from 12,000 to 30,000, more preferably from 13,500 to 25,000, still more preferably from 15,000 to 23,000, still further more preferably from 16,000 to 21,000. When the viscosity-average molecular weight Mv falls within the above-mentioned ranges, there can be obtained a gas separation membrane having more excellent selectivity, and a more excellent transmission amount, of carbon dioxide, and more excellent mechanical strength.

The viscosity-average molecular weight (Mv) of the polycarbonate-polyorganosiloxane copolymer (A) may be appropriately adjusted by using, for example, a molecular weight modifier (terminal stopper) so as to be a target molecular weight.

The viscosity-average molecular weight (Mv) is a value calculated from the following Schnell's equation by measuring the limiting viscosity [η] of a methylene chloride solution at 20° C.

$$[ η ] = 1.23 \times 1 {0}^{- 5} \times {Mv}^{0.83}$$

### (Method of Producing Polycarbonate-Polyorganosiloxane Copolymer (A))

The polycarbonate-polyorganosiloxane copolymer (A) may be produced by a known production method, such as an interfacial polymerization method (phosgene method), a pyridine method, or an ester exchange method. Particularly when the interfacial polymerization method is adopted, a step of separating an organic phase containing the polycarbonate-polyorganosiloxane copolymer and an aqueous phase containing an unreacted product, a catalyst residue, or the like becomes easier, and hence the separation of the organic phase containing the polycarbonate-polyorganosiloxane copolymer and the aqueous phase in each washing step based on, for example, alkali washing, acid washing, or pure water washing becomes easier. Accordingly, the polycarbonate-polyorganosiloxane copolymer is efficiently obtained. With regard to a method of producing the polycarbonate-polyorganosiloxane copolymer, reference may be made to, for example, a method described in JP 2014-80462 A.

In the interfacial polymerization method (phosgene method), for example, a dihydric phenol-based compound and a carbonate precursor such as phosgene are polymerized to produce a polycarbonate oligomer in advance, and then the polycarbonate oligomer, a polyorganosiloxane, and as required, the dihydric phenol-based compound are polymerized to produce the PC-POS copolymer (S-1).

Specifically, the polycarbonate-polyorganosiloxane copolymer (A) may be produced by: dissolving a polycarbonate oligomer produced in advance to be described later and a polyorganosiloxane in a water-insoluble organic solvent (e.g., methylene chloride); adding a solution of a dihydric phenol-based compound (e.g., bisphenol A) in an aqueous alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol, such as p-tert-butylphenol). In addition, the polycarbonate-polyorganosiloxane copolymer (A) may also be produced by copolymerizing, for example, the polyorganosiloxane and the dihydric phenol-based compound, and phosgene, a carbonate ester, or a chloroformate.

A polyorganosiloxane represented by the following general formula (1), general formula (2), and/or general formula (3) may be used as the polyorganosiloxane serving as a raw material:

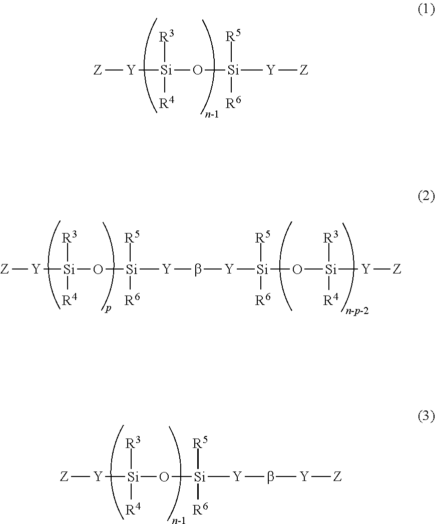

wherein R³ to R⁶, Y, β, “n”, and “p” are as described above.

Specific examples of R³ to R⁶, Y, β, “n” and “p”, and preferred examples thereof are also as described above.

Z represents hydrogen or a halogen atom, and a plurality of Zs may be identical to or different from each other.

Examples of the polyorganosiloxane represented by the general formula (1) include compounds represented by the following general formulae (1-1) to (1-11):

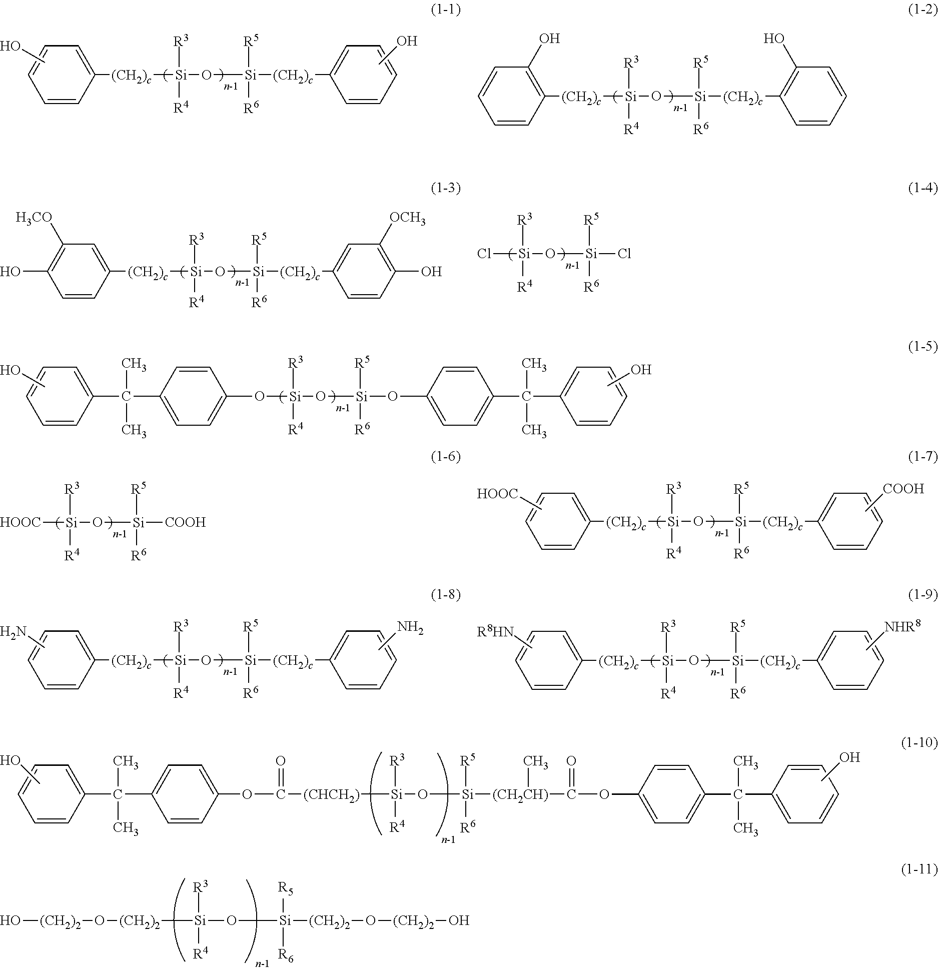

wherein in the general formulae (1-1) to (1-11), R³ to R⁶, n−1, and R⁸ are the same as those described above, and preferred examples thereof are also the same as those described above, and “c” represents a positive integer and typically represents an integer of from 1 to 6.

Among them, a phenol-modified polyorganosiloxane represented by the general formula (1-1) is preferred from the viewpoint of the ease with which the polyorganosiloxane is polymerized. In addition, an α,ω-bis[3-(o-hydroxyphenyl)propyl]polydimethylsiloxane, which is one compound represented by the general formula (1-2), or an α,ω-bis[3-(4-hydroxy-3-methoxyphenyl)propyl]polydimethylsiloxane, which is one compound represented by the general formula (1-3), is preferred from the viewpoint of its ease of availability.

In addition to the foregoing, a polyorganosiloxane represented by the following general formula (4) may be used as a polyorganosiloxane raw material:

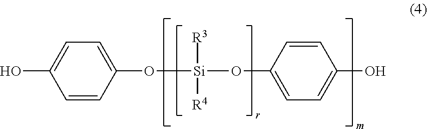

wherein R³, R⁴, “r”, and “m” are the same as those described above.

In addition to the foregoing, a polyorganosiloxane represented by the following general formula (5) or (6) may be used as the polyorganosiloxane raw material:

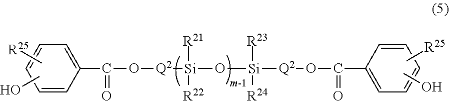

wherein R²¹ to R²⁵, Q², and “m” are the same as those described above;

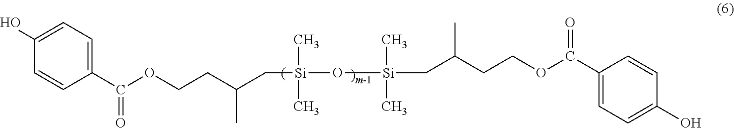 [SMILES: CC(CCOC(=O)c1ccc(O)cc1)C[Si](C)(C)O[Si](C)(C)CC(C)CCOC(=O)c1ccc(O)cc1]

wherein “m” is the same as that described above.

A method of producing the polyorganosiloxane is not particularly limited. According to, for example, a method described in JP 11-217390 A, a crude polyorganosiloxane may be obtained by: causing cyclotrisiloxane and disiloxane to react with each other in the presence of an acid catalyst to synthesize α,ω-dihydrogen organopentasiloxane; and then subjecting the α,ω-dihydrogen organopentasiloxane to an addition reaction with, for example, a phenolic compound (e.g., 2-allylphenol, 4-allylphenol, eugenol, or 2-propenylphenol) in the presence of a catalyst for a hydrosilylation reaction. In addition, according to a method described in JP 2662310 B2, the crude polyorganosiloxane may be obtained by: causing octamethylcyclotetrasiloxane and tetramethyldisiloxane to react with each other in the presence of sulfuric acid (acid catalyst); and subjecting the resultant α,ω-dihydrogen organopolysiloxane to an addition reaction with the phenolic compound or the like in the presence of the catalyst for a hydrosilylation reaction in the same manner as that described above. The α,ω-dihydrogen organopolysiloxane may be used after its chain length “n” has been appropriately adjusted in accordance with its polymerization conditions, or a commercial α,ω-dihydrogen organopolysiloxane may be used. Specifically, a polyorganosiloxane described in JP 2016-098292 A may be used.

The polycarbonate oligomer may be produced by a reaction between a dihydric phenol and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol and a carbonate precursor, such as diphenyl carbonate.

A dihydric phenol represented by the following general formula (viii) is preferably used as the dihydric phenol:

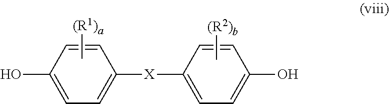

wherein R¹, R², “a”, “b”, and X are as described above.

Examples of the dihydric phenol represented by the general formula (viii) include: bis(hydroxyphenyl)alkane-based dihydric phenols, such as 2,2-bis(4-hydroxyphenyl)propane [bisphenol A], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenols may be used alone or as a mixture thereof.

Among them, bis(hydroxyphenyl)alkane-based dihydric phenols are preferred, and bisphenol A is more preferred. When bisphenol A is used as the dihydric phenol-based compound, the PC-POS copolymer is such that in the general formula (i), X represents an isopropylidene group and a=b=0.

Examples of the dihydric phenol-based compound except bisphenol A include bis(hydroxyaryl)alkanes, bis(hydroxyaryl)cycloalkanes, dihydroxyaryl ethers, dihydroxydiaryl sulfides, dihydroxydiaryl sulfoxides, dihydroxydiaryl sulfones, dihydroxydiphenyls, dihydroxydiaryl fluorenes, and dihydroxydiaryl adamantanes. Those dihydric phenol-based compounds may be used alone or as a mixture thereof.

Examples of the bis(hydroxyaryl)alkanes include bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-3-tert-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkanes include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ethers include 4,4′-dihydroxydiphenyl ether and 4,4′-dihydroxy-3,3′-dimethylphenyl ether.

Examples of the dihydroxydiaryl sulfides include 4,4′-dihydroxydiphenyl sulfide and 4,4′-dihydroxy-3,3′-dimethyldiphenyl sulfide. Examples of the dihydroxydiaryl sulfoxides include 4,4′-dihydroxydiphenyl sulfoxide and 4,4′-dihydroxy-3,3′-dimethyldiphenyl sulfoxide. Examples of the dihydroxydiaryl sulfones include 4,4′-dihydroxydiphenyl sulfone and 4,4′-dihydroxy-3,3′-dimethyldiphenyl sulfone.

An example of the dihydroxydiphenyls is 4,4′-dihydroxydiphenyl. Examples of the dihydroxydiaryladamantanes include 1,3-bis(4-hydroxyphenyl) adamantane, 2,2-bis(4-hydroxyphenyl) adamantane, and 1,3-bis(4-hydroxyphenyl)-5,7-dimethyladamantane.

Examples of the dihydric phenol-based compound except those described above include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

In order to adjust the molecular weight of the PC-POS copolymer to be obtained, a terminal stopper (molecular weight modifier) may be used. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

After the interfacial polycondensation reaction, the polycarbonate-polyorganosiloxane copolymer (A) may be obtained by appropriately leaving the resultant at rest to separate the resultant into an aqueous phase and an organic solvent phase [separating step], washing the organic solvent phase (preferably washing the phase with a basic aqueous solution, an acidic aqueous solution, and water in the stated order) [washing step], concentrating the resultant organic phase [concentrating step], and drying the concentrated phase [drying step].

### <Gas Separation Membrane>

The gas separation membrane of the present invention includes the polycarbonate-polyorganosiloxane copolymer (A). The content of the polycarbonate-polyorganosiloxane copolymer (A) in the gas separation membrane is preferably 80 mass % or more, more preferably 95 mass % or more, still more preferably 99 mass %, still further more preferably 100 mass %. When the content of the polycarbonate-polyorganosiloxane copolymer (A) in the gas separation membrane falls within the above-mentioned ranges, there can be obtained a gas separation membrane having more excellent selectivity, and a more excellent transmission amount, of carbon dioxide, and more excellent mechanical strength.

The thickness of the gas separation membrane of the present invention is preferably from 1 μm or more to 1,000 μm or less, more preferably from 5 μm or more to 500 μm or less, still more preferably from 10 μm or more to 250 μm or less. When the thickness of the gas separation membrane falls within the ranges, there can be obtained a gas separation membrane having a more excellent transmission amount of carbon dioxide and more excellent tear strength.

The gas separation membrane may include any other additive to the extent that the effects of the present invention are not impaired. Examples of the other component may include a hydrolysis-resistant agent, an antioxidant, a UV absorber, a flame retardant, a flame retardant aid, a reinforcing material, a filler, an elastomer for an impact resistance improvement, a cross-linking agent, a pigment, and a dye.

### (Antioxidant)

A specific example of the other additive is an antioxidant.

The blending of the polycarbonate-based resin composition with the antioxidant can suppress the oxidative deterioration of the polycarbonate-based resin composition at the time of its melting, and hence can suppress, for example, the coloring thereof due to the oxidative deterioration. For example, a phosphorus-based antioxidant and/or a phenol-based antioxidant is suitably used as the antioxidant.

Examples of the phenol-based antioxidant include hindered phenols, such as n-octadecyl-3-(3,5-di-tert-butyl-4-hydroxyphenyl)propionate, 2,6-di-tert-butyl-4-methylphenol, 2,2′-methylenebis(4-methyl-6-tert-butylphenol), and pentaerythrityl-tetrakis[3-(3,5-di-tert-butyl-4-hydroxyphenyl)propionate].

Among those antioxidants, antioxidants each having a pentaerythritol diphosphite structure, such as bis(2,6-di-tert-butyl-4-methylphenyl)pentaerythritol diphosphite and bis(2,4-di-tert-butylphenyl)pentaerythritol diphosphite, and triphenylphosphine are preferred.

Examples of commercial products of the phenol-based antioxidant may include Irganox 1010 (manufactured by BASF Japan, product name), Irganox 1076 (manufactured by BASF Japan, trademark), Irganox 1330 (manufactured by BASF Japan, product name), Irganox 3114 (manufactured by BASF Japan, product name), BHT (manufactured by Takeda Pharmaceutical Company Limited., product name), CYANOX 1790 (manufactured by SOLVAY S.A., product name), and Sumilizer GA-80 (manufactured by Sumitomo Chemical Company, Limited, product name).

Examples of the phosphorus-based antioxidant include triphenyl phosphite, diphenyl nonyl phosphite, diphenyl (2-ethylhexyl) phosphite, tris(2,4-di-tert-butylphenyl) phosphite, tris(nonylphenyl) phosphite, diphenyl isooctyl phosphite, 2,2′-methylenebis(4,6-di-tert-butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylphenyl)ditridecyl phosphite, bis(2,4-di-tert-butylphenyl)pentaerythritol diphosphite, bis(2,6-di-tert-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecylphosphite-5-tert-butylphenyl) butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl(β-ethylcarboxyethyl)phosphine, tris(p-chlorophenyl)phosphine, tris(p-fluorophenyl)phosphine, benzyldiphenylphosphine, diphenyl(β-cyanoethyl) phosphine, diphenyl(p-hydroxyphenyl)phosphine, diphenyl(1,4-dihydroxyphenyl)-2-phosphine, and phenylnaphthylbenzylphosphine.

Examples of commercial products of the phosphorus-based antioxidant may include Irgafos 168 (manufactured by BASF Japan, product name), Irgafos 12 (manufactured by BASF Japan, product name), Irgafos 38 (manufactured by BASF Japan, product name), ADK STAB 2112 (manufactured by ADEKA Corporation, product name), ADK STAB C (manufactured by ADEKA Corporation, product name), ADK STAB 329K (manufactured by ADEKA Corporation, product name), ADK STAB PEP36 (manufactured by ADEKA Corporation, product name), JC-263 (manufactured by Johoku Chemical Co., Ltd., product name), Sandstab P-EPQ (manufactured by Clariant AG, product name), and Doverphos S-9228PC (manufactured by Dover Chemical, product name).

The above-mentioned antioxidants may be used alone or in combination thereof. The content of the antioxidant in the gas separation membrane of the present invention is preferably from 0.001 part by mass to 0.5 part by mass, more preferably from 0.01 part by mass to 0.3 part by mass, still more preferably from 0.05 part by mass to 0.3 part by mass with respect to 100 parts by mass of the gas separation membrane. When the content of the antioxidant with respect to 100 parts by mass of the gas separation membrane falls within the above-mentioned ranges, a sufficient antioxidant action is obtained.

Any one of the following cases is applicable to the gas separation membrane of the present invention: the membrane includes a single membrane including the polycarbonate-polyorganosiloxane copolymer (A); or the membrane is a laminate obtained by arranging, on a support, a membrane including the polycarbonate-polyorganosiloxane copolymer (A).

Examples of the support include a woven fabric and a non-woven fabric. Examples of the woven fabric and the non-woven fabric include fabrics each obtained by using a fiber formed from, for example, polyester, polypropylene, polyacrylonitrile, polyethylene, or polyamide.

The gas separation membrane of the present invention is a gas separation membrane for separating carbon dioxide from a mixed gas containing the carbon dioxide. Examples of a gas except the carbon dioxide in the mixed gas include carbon monoxide, nitrogen, oxygen, hydrogen, hydrogen sulfide, nitrogen oxide, sulfur oxide, a silane compound, fluorine, chlorine, a noble gas, and a hydrocarbon compound.

Examples of the nitrogen oxide include nitrogen monoxide and nitrogen dioxide. Examples of the sulfur oxide include sulfur monoxide, sulfur dioxide, and sulfur trioxide. Examples of the silane compound include a monosilane and a disilane. Examples of the noble gas include helium and argon. Examples of the hydrocarbon compound include methane, ethane, ethylene, propane, propylene, butane, and butylene.

A preferred aspect of the mixed gas is, for example, an exhaust gas from a factory, a power plant, or an automobile.

### (Production Method)

The gas separation membrane of the present invention may be produced by a known method. The gas separation membrane may be obtained by, for example, any one of various methods of producing molded bodies, such as an injection molding method, an injection compression molding method, an extrusion molding method, a blow molding method, a press molding method, a vacuum molding method, an expansion molding method, a cast molding method, a spin coat molding method, and a blade molding method, through use of a melt-kneaded product of the above-mentioned polycarbonate-polyorganosiloxane copolymer (A) or a pellet obtained therefrom as a raw material.

### (Physical Properties of Gas Separation Membrane)

The gas separation membrane of the present invention has excellent carbon dioxide selectivity.

The carbon dioxide selectivity may be evaluated by, for example, a gas transmission rate ratio GTR_{CO2}/GTR_{O2+N2} defined as the ratio of the gas transmission rate GTR_{CO2} of carbon dioxide to the total GTR_{O2+N2} of the gas transmission rates of oxygen and nitrogen.

The gas transmission rate ratio GTR_{CO2}/GTR_{O2+N2} of the gas separation membrane of the present invention is preferably 10.0 or more, more preferably 10.2 or more, still more preferably 10.4 or more.

In addition, the gas separation membrane of the present invention has excellent carbon dioxide transmittance.

The carbon dioxide transmittance may be evaluated by, for example, a carbon dioxide transmission coefficient.

The product of the carbon dioxide transmission coefficient [unit: Barrer] and thickness [unit: μm] of the gas separation membrane of the present invention is preferably 5.0×10³ or more, more preferably 1.0×10⁴ or more, still more preferably 1.0×10⁵ or more.

The gas transmission rate ratio and the carbon dioxide transmission coefficient are measured in conformity with the differential pressure method of JIS K 7126-1:2006. Specifically, the measurement is performed as follows: under the condition of a test temperature of 23° C. described in Examples, one of sides separated from each other with the gas separation membrane is kept in a vacuum state (low-pressure side); a mixed gas (N₂:O₂:CO₂=8:1:1) is introduced into the other side (high-pressure side) to set a pressure difference between the sides to 1 atmospheric pressure; and the total amount of N₂ and O₂, and the amount of a CO₂ gas, the gases having passed through the gas separation membrane to penetrate into the low-pressure side, are measured by gas chromatography.

In addition, the gas separation membrane of the present invention has excellent mechanical strength.

The mechanical strength may be evaluated by, for example, a nicked crescent tear strength in conformity with JIS K 6252-1:2015.

The nicked crescent tear strength of the gas separation membrane of the present invention in a MD direction measured in conformity with JIS K 6252-1:2015 is preferably 10 kN/m or more, more preferably 30 kN/m or more, still more preferably 100 kN/m or more.

### (Application)

A use form of the gas separation membrane of the present invention is, for example, an exhaust gas-purifying apparatus including the gas separation membrane of the present invention.

<Use for Separation of Carbon Dioxide from Mixed Gas Containing Carbon Dioxide>

The present invention also provides a use of a polymer membrane including the above-mentioned polycarbonate-polyorganosiloxane copolymer (A) for separation of carbon dioxide from a mixed gas containing the carbon dioxide.

<Method of Separating Carbon Dioxide from Mixed Gas Containing Carbon Dioxide>

The present invention also provides a method of separating carbon dioxide from a mixed gas containing the carbon dioxide.

Specifically, the method of separating carbon dioxide of the present invention includes a step of bringing the mixed gas containing the carbon dioxide into contact with the above-mentioned gas separation membrane.

Although an aspect in which the mixed gas is brought into contact with the gas separation membrane is not particularly limited, the following aspect is preferred: the mixed gas is supplied to one surface of the gas separation membrane; the mixed gas penetrates the gas separation membrane; and a gas in which the concentration of the carbon dioxide has increased is recovered from the other surface of the gas separation membrane.

In such aspect, a pressure difference between the side to which the mixed gas is supplied and the side from which the gas is recovered is preferably from 0.01 atmospheric pressure or more to 1,000 atmospheric pressures or less, more preferably from 0.01 atmospheric pressure or more to 1,000 atmospheric pressures or less. One atmospheric pressure is equal to 0.101 MPa.

### EXAMPLES

The present invention is more specifically described by way of Examples. However, the present invention is by no means limited by these examples. In each of examples, characteristic values and evaluation results were determined in the following manner.

### (1) Average Chain Length and Content of Polyorganosiloxane Block (A-2)

The average chain length and content of the polyorganosiloxane block (A-2) were calculated by ¹H-NMR measurement from the integrated value ratio of a methyl group of a polydimethylsiloxane for forming the polyorganosiloxane block (A-2). Herein, the polydimethylsiloxane is sometimes abbreviated as PDMS.

### <Quantification Method for Average Chain Length of Polyorganosiloxane Block (A-2)>

### (¹H-NMR Measurement Conditions)

NMR apparatus: ECA-500 manufactured by JEOL Resonance Co., Ltd.
Probe: 50TH5AT/FG2
Measurement nucleus: ¹H
Observed range: −5 ppm to 15 ppm
Observation center: 5 ppm
Pulse repetition time: 9 sec
Pulse width: 45°
NMR sample tube: 5 φ
Sample amount: 30 mg to 40 mg
Solvent: deuterochloroform
Measurement temperature: room temperature
Number of scans: 256 times

### (Calculation Method for Average Chain Length of Polyorganosiloxane Block (A-2))

### ·Allylphenol-Terminated Polydimethylsiloxane

A: an integrated value of a methyl group in a dimethylsiloxane moiety observed around δ−0.02 to δ 0.5
B: an integrated value of a methylene group in allylphenol observed around δ 2.50 to δ 2.75
Chain length of polydimethylsiloxane=(A/6)/(B/4)

### Eugenol-Terminated Polydimethylsiloxane

A: an integrated value of a methyl group in a dimethylsiloxane moiety observed around δ−0.02 to δ 0.5
B: an integrated value of a methylene group in eugenol observed around δ 2.40 to δ 2.70
Chain Length of Polydimethylsiloxane=(A/6)/(B/4)

### <Quantification Method for Content of Polyorganosiloxane Block (A-2)>

(Example) quantification method for the copolymerization amount of a polydimethylsiloxane in a p-tert-butylphenyl (PTBP)-terminated polycarbonate obtained by copolymerizing an allylphenol-terminated polydimethylsiloxane.

### (¹H-NMR Measurement Conditions)

NMR apparatus: ECA-500 manufactured by JEOL Resonance Co., Ltd.
Probe: 50TH5AT/FG2
Measurement nucleus: ¹H
Observed range: −5 ppm to 15 ppm
Observation center: 5 ppm
Pulse repetition time: 9 sec
Pulse width: 45°
Number of scans: 256 times
NMR sample tube: 5 φ
Sample amount: 30 mg to 40 mg
Solvent: deuterochloroform
Measurement temperature: room temperature

### (Calculation Method for Content of Polyorganosiloxane Block (A-2))

A: an integrated value of a methyl group in a bisphenol A (BPA) moiety observed around δ 1.5 to δ 1.9
B: an integrated value of a methyl group in a dimethylsiloxane moiety observed around δ −0.02 to δ 0.3
C: an integrated value of a butyl group in a p-tert-butylphenyl (PTBP) moiety observed around δ 1.2 to δ 1.4

$$a = A / 6$$

$$b = B / 6$$

$$c = C / 9$$

$$T = a + b + c$$

$$f = a / T \times 100$$

$$g = b / T \times 100$$

$$h = c / T \times 100$$

$$TW = f \times 254 + g \times 74.1 + h \times 149$$

$$PDMS ( \% ) = g \times 7 4.1 / TW \times 100$$

### (2) Viscosity-Average Molecular Weight

A viscosity-average molecular weight (Mv) was calculated from the following equation (Schnell's equation) by using a limiting viscosity [η] determined through the measurement of the viscosity of a methylene chloride solution at 20° C. with an Ubbelohde-type viscometer.

$$[ η ] = 1.23 \times 1 {0}^{- 5} \times {Mv}^{0.83}$$

### Synthesis Example 1: Production of Polycarbonate Oligomer

Sodium dithionite (Na₂S₂O₄) was added to 5.6 mass % aqueous sodium hydroxide so that its concentration became 2,000 ppm with respect to bisphenol A (BPA) to be dissolved later. Then, BPA was dissolved in the mixture so that the concentration of BPA was 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket. The reaction liquid that had exited the tubular reactor was continuously introduced into a baffled vessel-type reactor provided with a sweptback blade and having an internal volume of 40 L. The solution of BPA in aqueous sodium hydroxide, 25 mass % aqueous sodium hydroxide, water, and a 1 mass % aqueous solution of triethylamine were further added to the reactor at flow rates of 2.8 L/hr, 0.07 L/hr, 17 L/hr, and 0.64 L/hr, respectively, to perform a reaction. An aqueous phase was separated and removed by continuously taking out the reaction liquid overflowing the vessel-type reactor and leaving the reaction liquid at rest. Then, a methylene chloride phase was collected.

The polycarbonate oligomer thus obtained had a concentration of 227 g/L and a chloroformate group concentration of 0.80 mol/L.

### <Production Example 1: Production of Polycarbonate-Polyorganosiloxane Copolymer>

15.8 Liters of the polycarbonate oligomer solution (PCO) produced in Synthesis Example 1 described above, 20 L of methylene chloride, 1,600 g of an allylphenol terminal-modified polydimethylsiloxane having an average chain length “n” of 37, and 0.104 mL (72.2 mmol) of triethylamine (TEA) were loaded into a 50-liter separable flask including a baffle board and a mechanical stirrer with a stirring blade. Aqueous sodium hydroxide A (NaOHaq) prepared in advance (by dissolving 101 g (2.53 mol) of sodium hydroxide in 1.16 L of ion-exchanged water) was added to the mixture under stirring, and a reaction between the polycarbonate oligomer and the allylphenol terminal-modified PDMS was performed for 20 minutes.

A solution of p-tert-butylphenol (PTBP: manufactured by DIC Corporation) in methylene chloride [obtained by dissolving 109 g (0.727 mol) of PTBP in 434 mL of methylene chloride] and a solution B of BPA in aqueous sodium hydroxide [obtained by dissolving 1,040 g (4.56 mol) of bisphenol A, 658 g (16.5 mol) of NaOH, and 0.031 g (11.9 mmol) of sodium dithionite (Na₂S₂O₄) in 9.62 L of ion-exchanged water] were added to the resultant polymerization liquid to perform a polymerization reaction for 20 minutes.

After the completion of the polymerization, the reaction liquid was transferred to a separating funnel, and was left at rest to be separated into an organic phase and an aqueous phase. After that, the organic phase was transferred to another separating funnel. The organic phase was sequentially washed with 4.45 L of 0.03 mol/L aqueous NaOH and 4.25 L of 0.2 mol/L hydrochloric acid. Next, the washed product was repeatedly washed with ion-exchanged water until an electric conductivity in an aqueous phase after the washing became 10 μS/m or less.

An organic phase obtained after the washing was transferred to a vat, and was dried in an explosion-proof drying machine (under a nitrogen atmosphere) at 48° C. overnight. Thus, a sheet-like PC-POS copolymer was obtained. The sheet-like PC-POS copolymer was cut to provide a flaky PC-POS copolymer (A1). The PC-POS copolymer (A1) had a viscosity-average molecular weight (Mv) of 18,300, its polyorganosiloxane block (A-2) had an average chain length of 37, and the content of the polyorganosiloxane block (A-2) therein was 28 mass %.

### <Production Example 2: Production of Polycarbonate-Polyorganosiloxane Copolymer>

Production was performed in the same manner as in Production Example 1 except that: the amounts of the polycarbonate oligomer solution (PCO), methylene chloride, and the allylphenol terminal-modified polydimethylsiloxane were set to 14.9 L, 18.9 L, and 3,480 g, respectively; a solution obtained by dissolving 95.3 g (2.38 mol) of NaOH in 1.10 L of ion-exchanged water was used as the aqueous sodium hydroxide A; 102 g (0.680 mol) of PTBP was used; and a solution obtained by dissolving 978 g (4.30 mol) of bisphenol A, 619 g (15.5 mmol) of NaOH, and 1.96 g (11.3 mmol) of Na₂S₂O₄ in 9.06 L of ion-exchanged water was used as the aqueous sodium hydroxide B. Thus, a PC-POS copolymer (A2) was obtained. The PC-POS copolymer (A2) had a viscosity-average molecular weight (Mv) of 17,900, its polyorganosiloxane block (A-2) had an average chain length of 38, and the content of the polyorganosiloxane block (A-2) therein was 46 mass %.

### <Production Example 3: Production of Polycarbonate-Polyorganosiloxane Copolymer>

Production was performed in the same manner as in Production Example 1 except that: the amounts of the polycarbonate oligomer solution (PCO), methylene chloride, and the allylphenol terminal-modified polydimethylsiloxane were set to 14.7 L, 18.7 L, and 4,770 g, respectively; a solution obtained by dissolving 94.1 g (2.35 mol) of NaOH in 1.08 L of ion-exchanged water was used as the aqueous sodium hydroxide A; 95.8 g (0.639 mol) of PTBP was used; and a solution obtained by dissolving 966 g (4.24 mol) of bisphenol A, 612 g (15.5 mmol) of NaOH, and 1.93 g (11.1 mmol) of Na₂S₂O₄ in 8.95 L of ion-exchanged water was used as the aqueous sodium hydroxide B. Thus, a PC-POS copolymer (A3) was obtained. The PC-POS copolymer (A3) had a viscosity-average molecular weight (Mv) of 17,400, its polyorganosiloxane block (A-2) had an average chain length of 38, and the content of the polyorganosiloxane block (A-2) therein was 55 mass %.

### <Production Example 4: Production of Polycarbonate-Polyorganosiloxane Copolymer>

Production was performed in the same manner as in Production Example 1 except that: the amounts of the polycarbonate oligomer solution (PCO), methylene chloride, and the allylphenol terminal-modified polydimethylsiloxane were set to 14.7 L, 18.7 L, and 3,480 g, respectively; a solution obtained by dissolving 95.3 g (2.38 mol) of NaOH in 1.10 L of ion-exchanged water was used as the aqueous sodium hydroxide A; 102 g (0.680 mol) of PTBP was used; and a solution obtained by dissolving 966 g (4.24 mol) of bisphenol A, 612 g (15.5 mmol) of NaOH, and 1.93 g (11.3 mmol) of Na₂S₂O₄ in 8.95 L of ion-exchanged water was used as the aqueous sodium hydroxide B. Thus, a PC-POS copolymer (A4) was obtained. The PC-POS copolymer (A4) had a viscosity-average molecular weight (Mv) of 19,800, its polyorganosiloxane block (A-2) had an average chain length of 40, and the content of the polyorganosiloxane block (A-2) therein was 56 mass %.

### <Production Example 5: Production of Polycarbonate-Polyorganosiloxane Copolymer>

Production was performed in the same manner as in Production Example 1 except that: the amounts of the polycarbonate oligomer solution (PCO), methylene chloride, the allylphenol terminal-modified polydimethylsiloxane, and triethylamine (TEA) were set to 129 mL, 171 mL, 85.0 g, and 0.083 mL (0.60 mmol), respectively; a solution obtained by dissolving 0.8 g (20 mmol) of NaOH in 10 mL of ion-exchanged water was used as the aqueous sodium hydroxide A; a solution obtained by dissolving 0.98 g (6.5 mmol) of PTBP in 10 mL of methylene chloride was used as a solution of PTBP in methylene chloride; and a solution obtained by dissolving 7.9 g (28 mmol) of bisphenol A, 5.4 g (136 mmol) of NaOH, and 0.02 g (0.11 mmol) of Na₂S₂O₄ in 80 mL of ion-exchanged water was used as the aqueous sodium hydroxide B. Thus, a PC-POS copolymer (A5) was obtained. The PC-POS copolymer (A5) had a viscosity-average molecular weight (Mv) of 17,900, its polyorganosiloxane block (A-2) had an average chain length of 40, and the content of the polyorganosiloxane block (A-2) therein was 65 mass %.

### <Production Example 6: Production of Polycarbonate-Polyorganosiloxane Copolymer>

Production was performed in the same manner as in Production Example 1 except that: the amounts of the polycarbonate oligomer solution (PCO), methylene chloride, and the allylphenol terminal-modified polydimethylsiloxane were set to 12.4 L, 14.7 L, and 3,045 g, respectively; a solution obtained by dissolving 57 g (1.43 mol) of NaOH in 0.653 L of ion-exchanged water was used as the aqueous sodium hydroxide A; 41.7 g (0.278 mol) of PTBP was used; and a solution obtained by dissolving 715 g (3.13 mol) of bisphenol A, 715 g (3.13 mol) of NaOH, and 369 g (9.2 mmol) of Na₂S₂O₄ in 5.4 L of ion-exchanged water was used as the aqueous sodium hydroxide B. Thus, a PC-POS copolymer (A6) was obtained. The PC-POS copolymer (A6) had a viscosity-average molecular weight (Mv) of 24,900, its polyorganosiloxane block (A-2) had an average chain length of 37, and the content of the polyorganosiloxane block (A-2) therein was 55 mass %.

### Examples 1 to 5

### (1) Production of Gas Separation Membrane

The PC-POS copolymers obtained in Production Examples 1 to 4 described above, the copolymers being shown in Table 1, were each melt-kneaded to be pelletized, and the pellet was subjected to extrusion molding to provide a film having a thickness shown in Table 1.

### (2) Evaluation Test of Carbon Dioxide-separating Performance

The evaluation test of carbon dioxide-separating performance in each of the resultant gas separation membranes was performed in conformity with the differential pressure method of JIS K 7126-1:2006. Specifically, the measurement was performed as follows: one of sides separated from each other with the gas separation membrane was kept in a vacuum state (low-pressure side); a mixed gas (N₂:O₂:CO₂=8:1:1) was introduced into the other side (high-pressure side); and the total amount of nitrogen (N₂) and oxygen (O₂), and the amount of a carbon dioxide (CO₂) gas, the gases having passed through the gas separation membrane to penetrate into the low-pressure side, were measured by gas chromatography.

A test temperature was 23° C., a pressure difference between both the surfaces of the gas separation membrane was 1 atmospheric pressure, and the area of the gas-transmitting portion thereof was 15.2×10⁻⁴ m² in each of Examples 1, 2, and 4, or was 0.785×10⁻⁴ m² in each of Examples 3 and 5.

The following measuring apparatus was used.

Differential pressure-type gas-vapor transmittance-measuring apparatus: GTR-30XADJ4, manufactured by GTR TEC Corporation
Gas chromatography detector: G2700T·F, manufactured by GTR TEC Corporation

A gas transmission rate (GTR) and a gas transmission coefficient (P) were calculated from the measured amount of the transmitted gas by using the following equations. The results are shown in Table 1.

$$Gas transmission rate ( G T R ) = 273 \times ( Dv - Db ) \times k / ( 22. 4 \times T \times A \times t \times Δ p )$$

GTR: a gas transmission rate [mol/(m²·s·Pa)]
T: a test temperature (K)
t: a transmission time(s)
Db: the blank amount (l) of the transmitted gas
Dv: the measured amount (l) of the transmitted gas
Δp: the partial pressure (Pa) of a high-pressure side gas
A: a transmission area (m²)
k: an apparatus constant for determining the entire volume of the low-pressure side from the volume of a measuring tube

$$Gas transmission coefficient ( P ) = G T R \times d$$

P: a gas transmission coefficient [mol·m/(m²·s·Pa)]
GTR: the gas transmission rate [mol/(m²·s·Pa)]
d: the average thickness (m) of a test piece (Thicknesses at 4 sites of the gas-transmitting portion were measured with a micrometer, and their average was used.)

In the table, the gas transmission coefficient was shown in a Barrer unit through conversion by the following equation.

$$1 Barrier = 335 \times 1 {0}^{- 16} mol \cdot m / ( {m}^{2} \cdot s \cdot Pa )$$

### (3) Evaluation of Mechanical Strength: Tear Test

The nicked crescent tear strength of each of the resultant gas separation membranes was measured in conformity with JIS K 6252-1:2015. Specifically, a crescent test piece was produced from the resultant gas separation membrane by punching. A nick having a length of 1.0 mm was made at the center of a recess of the test piece in a direction perpendicular to the surface of the test piece. A force was continuously applied with a tensile tester (INSTRON 5567, manufactured by Instron) at a tensile rate of 500 mm/min until the test piece ruptured.

A tear test was performed in the MD direction of the film, and its tear strength (Ts) was calculated from the following equation. The results are shown in Table 1.

$$Ts = F / d$$

Ts: a tear strength (kN/m)
F: the maximum load (kN)
d: the thickness (m) of the test piece

### Comparative Example 1

The evaluation test of carbon dioxide-separating performance and the evaluation test of mechanical strength were performed in the same manner as in Example 1 except that silicone (C1) (ultra-transparent silicone rubber film, model number: 3-9207-06, thickness: 0.2 mm, manufactured by AS ONE Corporation) was used as a gas separation membrane. The results are shown in Table 1.

TABLE 1

| | | | | | | | | | Comparative |
|---|---|---|---|---|---|---|---|---|---|
| | | | | Example | | | | | Example |
| | | | | 1 | 2 | 3 | 4 | 5 | 1 |
| PC-POS | Kind | | | A1 | A2 | A3 | A3 | A4 | — |
| | Viscosity-average molecular weight (Mv) | | | 18,300 | 17,900 | 17,400 | 17,400 | 19,800 | — |
| | (A-2) | Average chain length | | 37 | 38 | 38 | 38 | 40 | — |
| | | Content [mass %] | | 28 | 46 | 55 | 55 | 56 | — |
| Silicone | Kind | | | — | — | — | — | — | C1 |
| Gas | Thickness | [μm] | | 201 | 208 | 207 | 98 | 21 | 243 |
| separation | CO₂ | Gas transmission | O₂ + N₂ | 2.50 × | 1.30 × | 1.89 × | 3.74 × | 1.77 × | 4.20 × |
| membrane | selectivity | rate | | 10⁻¹¹ | 10⁻¹⁰ | 10⁻¹⁰ | 10⁻¹⁰ | 10⁻⁹ | 10⁻¹⁰ |
| | | [mol/(m² · s · Pa)] | CO₂ | 2.82 × | 1.34 × | 2.06 × | 3.93 × | 1.90 × | 4.13 × |
| | | | | 10⁻¹⁰ | 10⁻⁹ | 10⁻⁹ | 10⁻⁹ | 10⁻⁸ | 10⁻⁹ |
| | | Gas transmission | CO₂/(O₂ + | 11.28 | 10.31 | 10.90 | 10.51 | 10.73 | 9.83 |
| | | rate ratio | N₂) | | | | | | |
| | | Gas transmission | CO₂ | 1.69 × | 8.32 × | 1.27 × | 1.15 × | 1.19 × | 3.00 × |
| | | coefficient | | 10² | 10² | 10³ | 10³ | 10³ | 10³ |
| | | [Barrer] | | | | | | | |
| | | Gas transmission | CO₂ | 3.40 × | 1.73 × | 2.63 × | 1.13 × | 2.50 × | 7.29 × |
| | | coefficient × | | 10⁴ | 10⁵ | 10⁵ | 10⁵ | 10⁵ | 10⁵ |
| | | thickness | | | | | | | |
| | | [Barrer · μm] | | | | | | | |
| | Mechanical | Crescent tear strength [kN/m] | | 101.0 | 39.0 | 13.3 | 14.1 | 17.1 | 7.7 |
| | strength | | | | | | | | |

### Examples 6 to 8

### (1) Production of Gas Separation Membrane

2.17 Grams of the flake of each of the PC-POS polymers obtained in Production Examples 3, 5, and 6 described above was weighed in a 20-milliliter screw can, and 15 ml of dichloromethane was added thereto, followed by its dissolution by shaking. Thus, a polycarbonate solution (PC solution) was prepared. The resultant PC solution was poured into a petri dish having a diameter of 110 mm, and was left at rest at room temperature for 3 hours so that dichloromethane was volatilized. Thus, a film having a thickness shown in Table 2 was obtained.

### (2) Evaluation Test of Carbon Dioxide-Separating Performance

The evaluation test of carbon dioxide-separating performance in each of the resultant gas separation membranes was performed in conformity with the differential pressure method of JIS K 7126-1:2006. Specifically, the measurement was performed as follows: one of sides separated from each other with the gas separation membrane was kept in a vacuum state (low-pressure side); a mixed gas (N₂:O₂:CO₂=8:1:1) was introduced into the other side (high-pressure side); and the total amount of N₂ and O₂, and the amount of a CO₂ gas, the gases having passed through the gas separation membrane to penetrate into the low-pressure side, were measured by gas chromatography.

A test temperature was 23° C., a pressure difference between both the surfaces of the gas separation membrane was 1 atmospheric pressure, and the area of the gas-transmitting portion thereof was 50×10⁻⁴ m².

The following measuring apparatus was used.

High-sensitivity water vapor transmission rate-measuring apparatus: GTR-3000XATA, manufactured by GTR TEC Corporation

A gas transmission rate (GTR) and a gas transmission coefficient (P) were calculated from the measured amount of the transmitted gas in the same manner as in Example 1. The results are shown in Table 2.

TABLE 2

| | | | | Example | | |
|---|---|---|---|---|---|---|
| | | | | 6 | 7 | 8 |
| PC-POS | Kind | | | A3 | A5 | A6 |
| | Viscosity-average molecular weight (Mv) | | | 17,400 | 17,900 | 24,900 |
| | (A-2) | Average chain length | | 38 | 40 | 37 |
| | | Content [mass %] | | 55 | 65 | 55 |
| Gas | Thickness | [μm] | | 211 | 210 | 208 |
| separation | CO₂ | Gas transmission | O₂ + N₂ | 2.22 × | 2.77 × | 2.22 × |
| membrane | selectivity | rate | | 10⁻¹⁰ | 10⁻¹⁰ | 10⁻¹⁰ |
| | | [mol/(m² · s · Pa)] | CO₂ | 2.14 × | 2.55 × | 1.94 × |
| | | | | 10⁻⁹ | 10⁻⁹ | 10⁻⁹ |
| | | Gas transmission | CO₂/(O₂ + | 9.66 | 9.20 | 8.74 |
| | | rate ratio | N₂) | | | |
| | | Gas transmission | CO₂ | 1.35 × | 1.60 × | 1.20 × |
| | | coefficient | | 10² | 10² | 10² |
| | | [Barrer] | | | | |
| | | Gas transmission | CO₂ | 2.84 × | 3.36 × | 2.51 × |
| | | coefficient × | | 10⁴ | 10⁴ | 10⁴ |
| | | thickness | | | | |
| | | [Barrer · μm] | | | | |

### Examples 7′ and 8′

As can be seen from comparison between the results of Examples 3 and 6, the evaluation method used in each of Examples 1 to 5, and the evaluation method used in each of Examples 6 to 8 provide different results. In particular, the total gas transmission rates of N₂ and O₂ differ from each other.

In view of the foregoing, the total gas transmission rate of N₂ and O₂ (estimated value) determined by the evaluation method used in each of Examples 1 to 5 was estimated for each of the PC-POS copolymers obtained in Production Examples 5 and 6 by the following equation (A).

Further, a gas transmission coefficient (P) was calculated on the basis of the determined estimated value in the same manner as in Example 1.

The results are shown in Table 3.

$$X = Y \times ( 1.89 \times 1 {0}^{- 10} ) / ( 2.22 \times 1 {0}^{- 10} ) \qquad ( A )$$

X: the estimated value of the total gas transmission rate of N₂ and O₂ based on the method for the evaluation test of carbon dioxide-separating performance used in each of Examples 1 to 5
Y: the total gas transmission rate of N₂ and O₂ based on the method for the evaluation test of carbon dioxide-separating performance used in each of Examples 6 to 8

TABLE 3

| | | | | Example | |
|---|---|---|---|---|---|
| | | | | 7′ | 8′ |
| PC-POS | Kind | | | A5 | A6 |
| | Viscosity-average molecular weight (Mv) | | | 17,900 | 24,900 |
| | (A-2) | Average chain length | | 40 | 37 |
| | | Content [mass %] | | 65 | 55 |
| | Thickness | [μm] | | 210 | 208 |
| Gas | CO₂ | Gas transmission rate | O₂ + N₂ *1 | 2.36 × 10⁻¹⁰ | 1.86 × 10⁻¹⁰ |
| separation | selectivity | [mol/(m2 · s · Pa)] | CO₂ | 2.55 × 10⁻⁹ | 1.94 × 10⁻⁹ |
| membrane | | Gas transmission rate | CO₂/(O₂ + N₂) *1 | 10.80 | 12.03 |
| | | ratio | | | |
| | | Gas transmission | CO₂ | 1.60 × 10² | 1.20 × 10² |
| | | coefficient [Barrer] | | | |
| | | Gas transmission | CO₂ | 3.36 × 10⁴ | 2.51 × 10⁴ |
| | | coefficient × thickness | | | |
| | | [Barrer · μm] | | | |

*1 Estimated value

1. A gas separation membrane for separating carbon dioxide from a mixed gas comprising the carbon dioxide, the gas separation membrane comprising a polycarbonate-polyorganosiloxane copolymer (A),
wherein the polycarbonate-polyorganosiloxane copolymer (A) comprises a polycarbonate block (A-1) consisting of repetition of a structural unit represented by the following general formula (I) and a polyorganosiloxane block (A-2) comprising repetition of a structural unit represented by the following general formula (II), and
wherein a content of the polyorganosiloxane block (A-2) in the polycarbonate-polyorganosiloxane copolymer (A) is from 20 mass % or more to 70 mass % or less: 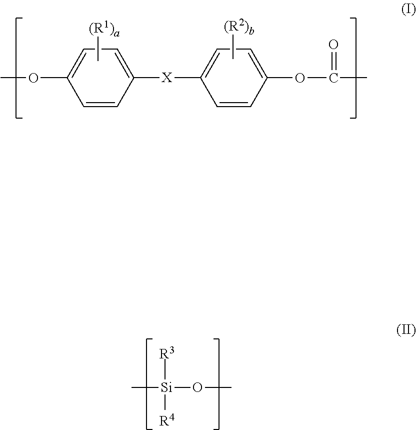
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

2. The gas separation membrane according to claim 1, wherein the polyorganosiloxane block (A-2) has an average chain length “n” of from 20 to 150.

3. The gas separation membrane according to claim 1, wherein in the general formula (I), “a” and “b” each represent 0, and X represents an isopropylidene group.

4. The gas separation membrane according to claim 1, wherein in the general formula (II), R³ and R⁴ each represent a methyl group.

5. The gas separation membrane according to claim 1, wherein a product of a carbon dioxide transmission coefficient [unit: Barrer] of the gas separation membrane and a thickness [unit: μm] thereof is 5.0×10³ or more.

6. The gas separation membrane according to claim 1, wherein the mixed gas comprising the carbon dioxide is an exhaust gas.

7. A use of a polymer membrane comprising a polycarbonate-polyorganosiloxane copolymer (A) for separation of carbon dioxide from a mixed gas comprising the carbon dioxide,
wherein the polycarbonate-polyorganosiloxane copolymer (A) comprises a polycarbonate block (A-1) consisting of repetition of a structural unit represented by the following general formula (I) and a polyorganosiloxane block (A-2) comprising repetition of a structural unit represented by the following general formula (II), and
wherein a content of the polyorganosiloxane block (A-2) in the polycarbonate-polyorganosiloxane copolymer (A) is from 20 mass % or more to 70 mass % or less: 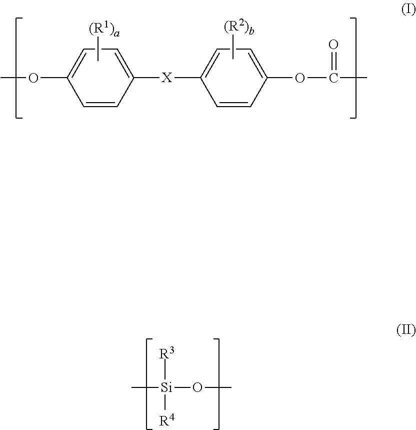
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.

8. A method of separating carbon dioxide from a mixed gas comprising the carbon dioxide, comprising a step of bringing the mixed gas comprising the carbon dioxide into contact with a gas separation membrane,
wherein the gas separation membrane comprises a polycarbonate-polyorganosiloxane copolymer (A),
wherein the polycarbonate-polyorganosiloxane copolymer (A) comprises a polycarbonate block (A-1) consisting of repetition of a structural unit represented by the following general formula (I) and a polyorganosiloxane block (A-2) comprising repetition of a structural unit represented by the following general formula (II), and
wherein a content of the polyorganosiloxane block (A-2) in the polycarbonate-polyorganosiloxane copolymer (A) is from 20 mass % or more to 70 mass % or less: 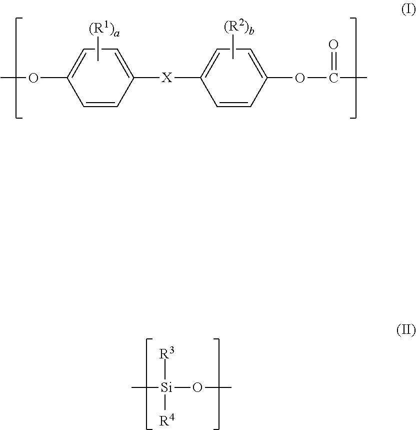
wherein R¹ and R² each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an arylalkylene group having 7 to 15 carbon atoms, an arylalkylidene group having 7 to 15 carbon atoms, —S—, —SO—, —SO₂—, —O—, or —CO—, R³ and R⁴ each independently represent hydrogen, a halogen atom, an alkyl group having 1 to 6 carbon atoms, an alkoxy group having 1 to 6 carbon atoms, or an aryl group having 6 to 12 carbon atoms, and “a” and “b” each independently represent an integer of from 0 to 4.
